(19) United States
(12) Patent Application Publication
(10) Pub. No.: US 2008/0109752 A1
(43) Pub. Date: May 8, 2008

(54) Expanding search query input box to support livesearch interaction

(75) Inventors: Oliver T. Bayley, Pacifica, CA (US); Ashley W. Hall, Menlo Park, CA (US); Swati Raju, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/594,593

(22) Filed: Nov. 7, 2006

(51) Int. Cl. G06F 17/00; G06F 3/00

(52) U.S. Cl. 715/800

(57) ABSTRACT

Techniques are described herein for a UI mechanism that supports interaction between user input and data related to the user input using a display screen. The UI mechanism first determines initial dimensions for an input region. As user inputs characters into the user input region, the UI mechanism enforces a constraint on the size of the user input region in the first direction and adapts the dimensions of the input region to fit the user input by resizing the user input box in the second direction. This allows the user input and related data to be displayed in sections on the display screen in a stable manner along a certain direction. This also allows the user to see an entire searchable text in a single glance and encourages the user to input more characters, or words, thereby leading to a highly pertinent set of results or suggestions.

### FIELD OF THE INVENTION

The present invention relates to supporting interaction between user input and data related to the user input using a display screen and in particular, to providing an expanding search query input box to support interaction between user input and search results.

### BACKGROUND OF THE INVENTION

A search engine is a computer program that helps a user locate information from various data sources such as the internet, intranets, a local hard disk, a portable memory card, etc. To interact with the search engine, a user is often provided a visual prompt on a display screen to input a searchable text, or a search query. Based on the searchable text inputted by the user, the search engine performs its search and returns relevant search results for display on the display screen. Various means can be used to support inputting the searchable text. For example, to input the searchable text, a user may type the searchable text with a keyboard attached to a personal computer, enter the searchable text with a keypad coupled to a PDA, write the searchable text on a certain surface provided by a pen-based system, or tap a touch-sensitive screen of a suitable system.

Whatever input means is used, for the purpose of providing a visual feedback of what has been inputted by the user, a visual prompt is usually provided in the form of an input region on the display screen. As the searchable text is being inputted by the user into an electronic device, the electronic device concurrently renders the searchable text in the input region on the display screen.

The input region commonly is a fixed-sized graphically demarcated region on the display screen. In the context of informational search, the input region is often limited to a single line. Since the horizontal line size, or width, of a single line is limited, as the user adds more text into the searchable text, the amount of the searchable text may exceed what the input region could accommodate. When that happens, only a portion of the searchable text, rather than the entire searchable text, could be made visible. Thus, a disadvantage of these common techniques is that the user cannot see the entire searchable text with a single glance. Furthermore, it is somewhat cumbersome to view other portions of the searchable text; the user would have to take extra steps such as hitting arrow keys or moving a cursor inside the input region until another portion of the searchable text appears. Thus, a further disadvantage of these common techniques is that extra effort on the part of the user is often required to view a long searchable text. As a result, the purpose of providing a visual feedback is, to a large extent, defeated when a searchable text cannot be rendered in the input region in its entirety.

In the context of informational search, a longer search text should be encouraged as it better leads to a set of highly pertinent information. That is, the longer the user's search query, the more precise and relevant the information returned. Unfortunately, because of the shortcomings previously described, these common techniques serve to discourage longer searchable texts.

A solution to the problems described above could be to set the input region as large as the display screen could physically accommodate. In the case of a single line input region, the horizontal size of the input region could be set to or near a full size of the display screen, for example. However, a disadvantage of this solution would be that, if the searchable text were small, the input region would appear inordinately large. Furthermore, precious display space would be wasted in this approach. More problematic, however, the search text could still be larger than what the input region could accommodate; the same problem of not seeing the entire searchable text as previously described would still occur.

To use display space efficiently, a solution may be to extend the horizontal line size of the input region as new text is being added. In other words, the line size of the input region may be increased to accommodate new text input. This would prevent wasting horizontal space where the searchable text is small. However, a disadvantage of the present solution would be that the increased line size would affect other data displayed in the display screen. For instance, it may adversely impact displaying other data such as the search results or advertisement links in an adjacent section of the display screen.

Furthermore, under these approaches, a frequent increase in the line size of the input region would induce a correspondingly frequent change in the horizontal size of the adjacent section where other data is displayed. This frequent fluctuation in the horizontal sizes of the input region and the adjacent section where other data is displayed would certainly produce a bewildering user experience.

Thus, a need exists for improved ways of supporting interaction between user input and data related to the user input using a display screen.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A, FIG. 1B, FIG. 1C, and FIG. 1D illustrate a graphical user interface for supporting interaction between user input and data related to the user input using a display screen, according to an embodiment of the present invention;

FIG. 2A and FIG. 2B illustrate a graphical user interface for supporting interaction between user input and search results, according to an embodiment of the present invention;

FIG. 3 is a flow diagram that illustrates a technique for supporting interaction between user input and data related to the user input using a display screen, according to an embodiment of the present invention; and

FIG. 4 is a block diagram that illustrates a computer system upon which embodiments of the invention may be implemented.

### DETAILED DESCRIPTION OF THE INVENTION

A method and apparatus for supporting interaction between user input and data related to the user input using a display screen is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

It has been observed that many users have preferences as to how information should be presented in a display screen. For example, in a European language, when searching for results that are related to a searchable text, a user may prefer an input box for inputting the searchable text on the left-hand side of a display screen and a display area for showing the search results on the right-hand side of the display screen. For a language such as Arabic or Hebrew, user preferences may differ from those for European languages; a user in an Arabic or Hebrew language may prefer an input box for inputting the searchable text on the right-hand side of a display screen and a display area for showing the search results on the left-hand side of the display screen. Given a particular language, users may prefer information to be presented in a certain desirable visual format that takes into account preferences associated with that particular language. In addition, given such preferences, sizes of display sections aligned along a first direction may preferably be unchanged irrespective of how many or few characters the searchable text contains; otherwise a bewildering experience may result from looking at a display screen containing fluctuating sizes of sections for various data displays.

In accordance with this observation, techniques are described herein for a user interface (UI) mechanism that supports interaction between user input and data related to the user input using a display screen. The UI mechanism first determines initial dimensions for an input region. An example of the initial dimensions is a single line of 300 pixels or 100 characters along the first direction. That is, the input region is initially set to a first size of 300 pixels or 100 characters in the first direction and a second size of a single line (e.g., 12 pixels) in a second direction.

As a user inputs characters into the user input region through an input means, at a certain point, the user input region can no longer fit the user input in the initial dimensions unless the dimensions of the user input region are enlarged. Similarly, as the user deletes characters from the user input region, at a certain point, the user input region contains extra blank line(s). At that point, the UI mechanism enforces a constraint on the size of the user input region along the first direction and adapts the dimensions of the input region to fit the user input by shrinking or resizing the user input box in the second direction. In one embodiment, even when the entire contents of the input region are deleted, the dimension along the second direction of the input region is at least one line. Because the adjustment of the dimensions is restricted to the second direction only, other data displayed in a section aligned along the first direction is not impacted by additions or deletions of characters from the user input region, thereby avoiding fluctuation of sizes of display sections along the first direction.

Furthermore, since the user input region can be resized to adapt itself to the user input, the user input can be viewed in its entirety. This allows the user to see an entire searchable text in a single glance, for example. This encourages the user to enter more characters. As a result, as the user input more characters, or words, in the user input region, informational search related to the user input is narrowed, likely leading to a highly pertinent set of results or suggestions.

In one embodiment, a list of suggestions (i.e. first data) can be concurrently retrieved and rendered as the user inputs the searchable text in the user input region. This list of suggestions can be displayed in a manner in which the list is visually aligned with the searchable text on the display screen. In one embodiment, if the user is a European language user, the list is displayed just below the user input region. Thus, the user gets not only a visual feedback of what has been typed but also suggestions related to words in the searchable text that has been inputted. As the suggestions are displayed right below the user input region, the user can easily correlate the suggestions with the searchable text. In one embodiment, the suggestions on the list are ranked. The list may be displayed in such a way that a suggestion corresponding to the most popular search term is the first on the list. In one embodiment, the suggestions are predictions of what the searchable text would be if completely entered by the user. In this embodiment, the list of suggestions may be ranked based on the likelihood that the searchable text will complete to a particular suggestion.

In one embodiment, search results corresponding to a suggestion are also concurrently retrieved and rendered on the display screen as the user inputs the searchable text in the user input region. The search results initially may correspond to the suggestion that is ranked as the most popular search term as previously stated. The user, however, can also select a suggestion in the displayed list of suggestions, for example, by clicking a mouse button over the suggestion. As a result, search results corresponding to the selected suggestion are retrieved and rendered on the display screen. In one embodiment, if the user is a European language user, the user input region and the list of suggestions are displayed in a first section of the display screen; search results are displayed in a second section of the display screen; and the first and second sections are horizontally aligned. In some embodiments, the horizontal size of the first region is fixed and amounts to a fraction (e.g., ¼) of a full horizontal size of the display screen and the horizontal size of the user input region is restricted to no more than the horizontal size of the first section.

Thus, techniques under the present invention can accommodate both small and large searchable text input without wasting space. Furthermore, by constraining the user input region and the suggestions in a section within a fixed horizontal size, search results are displayed in a section in a dimensionally stable manner, resulting in a pleasant user experience.

The user input and search results as described herein may pertain to the World Wide Web. However, this invention is not so limited. More generally, the user input and results may pertain to any searchable data in any format. For example, the data may be a user's address book, saved links, personally stored images (such as jpeg files, .gif files, etc.), video, audio (.mp3 files, .wmv files, etc.), contact cards (e.g., v-cards), calendar objects, word processing documents, graphics files, or computer code (object files and source code).

### Example Illustrations

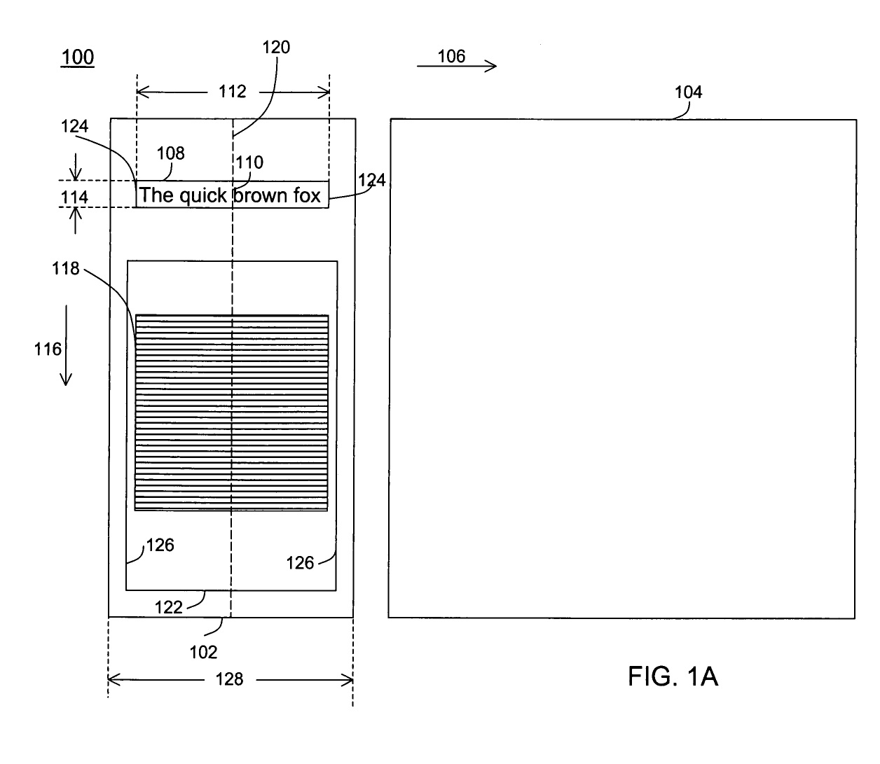

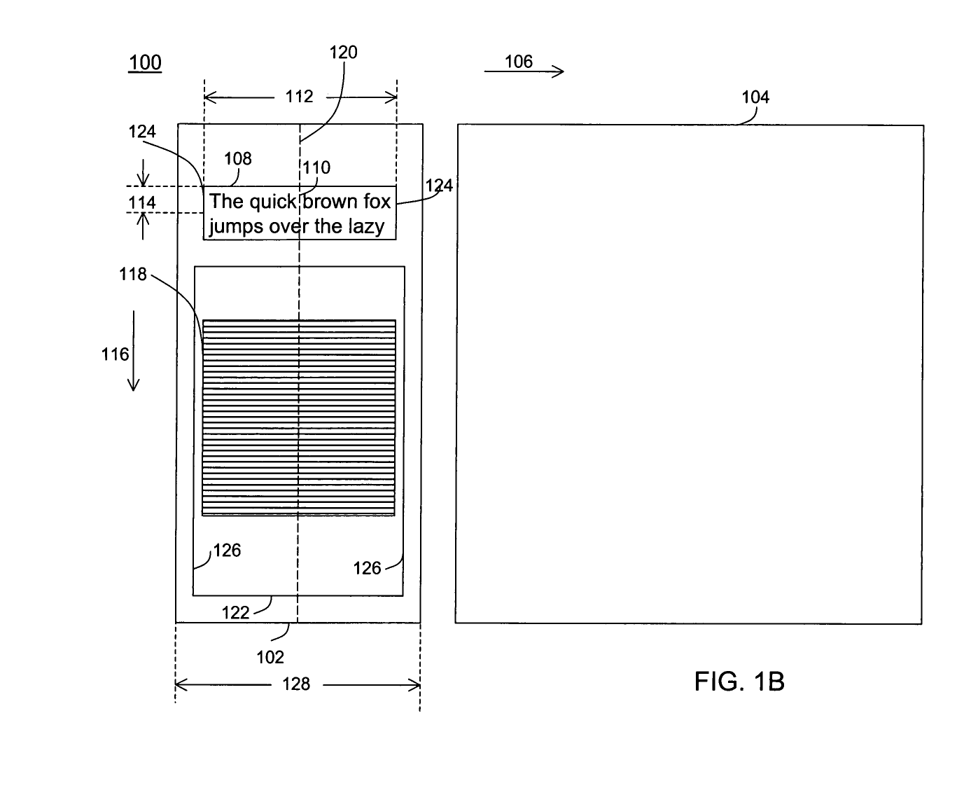

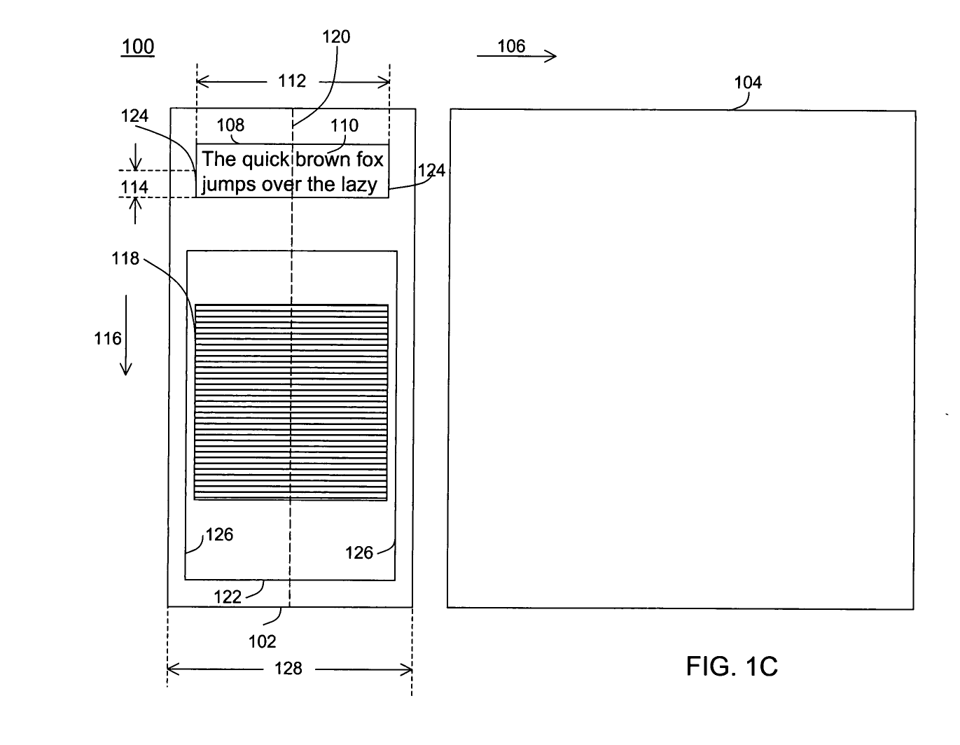

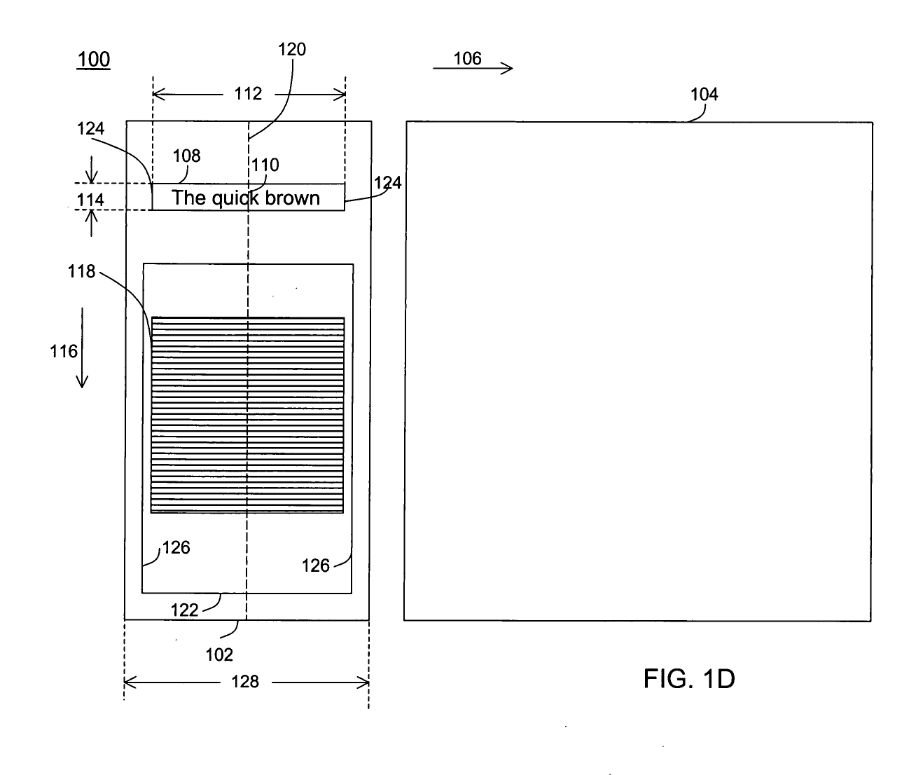

According to one embodiment, as shown in FIGS. 1A-1D, a display screen 100 comprises a first section 102 and a second section 104 aligned along a first direction 106. In one embodiment, the first direction 106 is a left-to-right horizontal direction, as shown in FIGS. 1A-1D. In another embodiment, the first direction may be a right-to-left horizontal direction (not shown). These and other variations of the first directions such as a downwards vertical direction (not shown) or an upwards vertical direction (not shown) are all within the present invention. As an example, to set up for displaying information in a European language such as English, the display screen 100 is divided into the first section 102 and the second section 104 aligned along the left-to-right horizontal direction, as shown in FIGS. 1A-1D.

As used herein, the term “direction” refers to a positional relationship between geometric objects. Here, geometric objects are defined as any portion, and/or any section, of the display screen 100 (whether they are presently rendered for display or not), or any graphic objects rendered or displayed in the display screen 100. A direction can be represented by an imaginary directed line (such as 106 of FIGS. 1A-1D). Here, the term “imaginary . . . line” means that the line may or may not actually be displayed or rendered in the display screen 100. For the purpose of illustration, a usage of the term “a first section and a second section aligned along a first direction” means that the first named geometric object, i.e., the first section, and the second named geometric object, i.e., the second section, are arrayed in a specific order parallel to the imaginary directed line that indicates the first direction 106. Conversely, a usage of a term “a first portion and a second portion aligned against a first direction” would mean that the first named geometric object, i.e., the first portion, and the second named geometric object, i.e., the second portion, would be arrayed in a reverse direction to the imaginary line that indicates the first direction 106. For example, suppose the first direction 106 is left-to-right horizontal direction. A phrase “the first named object and the second named object aligned along the first direction 106” would mean that the first named object and the second named object lines up in the left-to-right horizontal direction with the first named object on the left-hand side of the second named object. Conversely, a phrase “the first named object and the second named object aligned against the first direction 106” would mean that the second named object and the first named object lines up in the left-to-right horizontal direction, but with the first named object on the right-hand side of the second named object.

In one embodiment, a user input region 108 is rendered or displayed along the first direction 106. Here, the term “rendered . . . along the first direction” means additional characters to a user input 110 would be added along the first direction 106 if the additional characters could still fit in the user input region 108 without resizing the user input region 108. In accordance with an embodiment of the present invention, the user input region 108 is restricted from exceeding a fixed size 112 along the first direction 106. For example, in an embodiment where the user input region 108 is an input box graphic rendered in the horizontal direction, the input box is restricted from exceeding a fixed size, say, 300 pixels or 100 characters, in the horizontal direction.

As used herein, the term “a fixed size” does not mean that the fixed size 112 (of the user input region 108) cannot be changed at all, but rather simply means that the fixed size 112 is not responsive to any user input destined for the user input region 108. A user may still alter the fixed size 112 by invoking some preference configuration functionality. For example, a configuration page (not shown), similar to an “internet options” page provided by an internet browser, may be used to set an appropriate value for the fixed size 112.

In some embodiments, the fixed size 112 (of the user input region 108) is determined programmatically by an electronic device based on characteristics of the display screen. In one embodiment, the fixed size 112 thus determined or configured is smaller than a full size (e.g., ¼ of the full size), along the first direction, of the display screen.

In some embodiments, the user input region 108 is entirely located within the first section 102. Therefore, in one embodiment, the fixed size 112 that restricts the user input region 108 is less than a full size of the first section 102.

In contrast to the fixed size 112 along the first direction 106, the user input region has a non-fixed size 114 along a second direction 116. As used herein, the term “a non-fixed size” does not mean that the non-fixed size 114 changes all the time in response to any user input destined for the user input region 108, but rather changes when the user input 110 grows or shrinks to a point that the user input region 108 is deemed as not an appropriate size for the user input. For illustration purpose, the user input region 108 can be set to an initial value of a non-fixed size along the second direction 116 (which may be a downwards vertical direction, for example, as shown in FIGS. 1A-1D). This initial value may be 12 pixels or a single line (the height of a single text line). Suppose that the fixed size 112 of the user input region 108 (which may be a left-to-right horizontal direction, for example, as shown in FIGS. 1A-1D) is 300 pixels or 100 characters. In one embodiment, as long as the user input 110 can be rendered within the 300 pixels or 100 characters, the non-fixed size 114 of the user input region 108 does not change, even though a user adds characters to or removes characters from, or otherwise alters, the user input 110.

As noted before, the user input 110 can be received through any input means, which can be, but is not limited to, a keyboard attached to the electronic device. As part of receiving the user input, one or more characters can be added to the previously made user input. Conversely, as part of receiving the user input, one or more characters may be removed from the previously made user input. The user input 110 with its present content is rendered or displayed in the user input region 108. In one embodiment, a user may populate the user input region 108 by clicking on a suggestion that is presented to the user; and the user input region 108 may be repopulated with a text corresponding to the suggestion clicked. In one embodiment, a user may populate the user input region 108 by pasting; and the user input region 108 may be repopulated with a text pasted.

In accordance with an embodiment of the present invention, when the user input 110 is, or deemed as, no longer fitting the single line, the user input region 108 is resized along or against the second direction 116 to adapt the user input region 108 to the user input 110. That is, if two lines are needed to fit the user input 110, the user input region 108 is expanded in the second direction 116 and adapted to the user input 110. Here, the phrase “expanded in the second direction” refers to expansions either along or against the second direction 116.

In embodiments where the first direction 106 is the left-to-right horizontal direction and the second direction 116 is the downwards horizontal direction, a moment may be reached when the user input 110 could fit in a single horizontal line of the display screen 100 if the user input region 108 were to be resized horizontally. However as noted before, in accordance with an embodiment of the present invention, the user input region 108 is fixed in the first direction 106, i.e., the horizontal direction. In accordance with an embodiment of the present invention in which the user input region is fixed in the horizontal direction, to adapt the user input region 108 to the user input 110, the user input region 108 is expanded in the vertical direction. This expansion can be either along or against the vertical direction, as indicated in FIGS. 1B and 1C respectively (for the same increased user input, in FIG. 1B the input box is expanded along the vertical direction while in FIG. 1C the input box is expanded against the vertical direction), or can comprise simultaneous expansions both along and against the vertical direction.

Suppose that the user input region 108 now fits two lines, as shown in FIGS. 1B and 1C. If the user then deletes enough characters from the user input 110 so that the user input 110 could fit within a single line in the second direction 116, then the user input would no longer fit (in accordance with the meaning of the term “fit” as used herein) the user input region 108 because of the extra line. When this occurs, in one embodiment, the user input region 108 is shrunk in the second direction 116. Here, the phrase “shrunk in the second direction” refers to shrinkages either along or against the second direction 116.

In embodiments where the first direction 106 is the left-to-right horizontal direction and the second direction 116 is the downwards horizontal direction, as shown in FIGS. 1A-1D, the user input region, as noted, would be fixed along the horizontal direction, but can be shrunk in the vertical direction. Furthermore, shrinkage can be either along or against the vertical direction, as indicated in FIG. 1D (for the same decreased user input, in FIG. 1D the input box is shrunk back to its original single line format from FIGS. 1B and 1C), or can comprise simultaneous shrinkages both along and against the vertical direction.

In one embodiment, expansion and shrinkage are correlated. Thus, in such an embodiment, if expansion would be along the second direction 116, then shrinkage would be against the second direction 116; conversely, if expansion would be against the second direction 116, then shrinkage would be along the second direction 116.

As this discussion shows, the user input 110 is displayed in the user input region 108, as resized to adapt the user input region 108 to the user input 110. In some embodiments, limits are placed by the UI mechanism as to the minimum and maximum non-fixed size 114 can be. In one embodiment, the minimum size of the non-fixed size 114 is a single line. In one embodiment, the maximum size of the non-fixed size 114 is four lines. However the present invention is not limited to just these minimum and maximum sizes. Other variations of minimum and maximum sizes are also within the scope of the present invention.

For the purpose of illustration, resizing the user input region 108 has been described as physically expanding or shrinking the user input region 108. However, the term “resizing” here can also refer broadly to expansion or shrinkage of the user input region 108 in a logical, not just limited to a physical size or length-wise, sense. Here, the term “expansion or shrinkage in a logical sense” refers to any change of attributes associated with the user input region 108 so as to fit more or fewer characters without altering the fixed size 112 of the user input region 108 in the first direction 106 or, in one embodiment, the horizontal direction. Examples of the attributes associated with the user input region 108 are one or more attributes of a font that is used to render the user input 110 in the user input region 108. The one or more attributes of the font includes a font size. In some embodiments, resizing the user input region 108 to adapt it to the user input 110 is accomplished by a change of the font size with or without altering the non-fixed size 114.

In one embodiment, the user input 110 relates to first data 118. For example, in a situation where the user input 110 is a searchable text, the first data 118 can be some data based on the searchable text, such as suggested completions to the searchable text. In one embodiment, at the same time as the user inputs characters through the input means, the search engine concurrently retrieves the first data 118 related to the searchable text (whether the searchable text has been formally submitted for search by the user or not). In one embodiment, retrievals performed by the search engine occur more than once and are triggered upon certain criteria being met—for example, when a space character is inputted after a preceding word, after a carriage return is typed, or a “submit” icon or graphical button is clicked on, etc.

In one embodiment, the first data 118 retrieved is a list of suggestions related to the user input, as will be further illustrated later. In one embodiment, the list of suggestions is rendered or displayed in the first section 102 along a first axis 120 in a second direction 116. In some embodiments, the first axis 120 goes through the user input region 108. Furthermore, the user input 110 is visually aligned, along the first axis 120, with the first data 118. In one embodiment, displaying the first data comprises updating the first data to reflect the user input that is currently displayed in the user input region.

In embodiments where the first direction 106 is the left-to-right horizontal direction and the second direction 116 is the downwards horizontal direction, as shown in FIGS. 1A-1D, the first data 118 that is related to the user input 110 is displayed in a portion 122 of the display screen 100. In one embodiment, as shown in FIGS. 1A-1D, the portion 122 is entirely within the first section 102. Furthermore, the user input region 108 and the portion 122 of the display screen 100 are visually aligned along a vertical axis (i.e., the first axis 120). In one embodiment, horizontal boundaries 124 of the user input region are substantially aligned with horizontal boundaries 126 of the portion used to display the first data.

As previously noted, in accordance with an embodiment of the present invention, the display screen comprises the first section 102 and the second section 104 along the first direction. The first section 102 is of a size (128 of FIGS. 1A-1D) in the first direction 106. This size 128 is fixed relative to the user input 110 displayed in the user input region 108. In one embodiment, the size 128 of the first section 102 is smaller than the full size, in the first direction 106, of the display screen 100. As described above, in one embodiment, the first section 102 comprises the user input region 108 and the portion 122 used to display the first data 118.

For example, in one of the embodiments where the first direction 106 is the left-to-right horizontal direction and the second direction 116 is the downwards vertical direction, as shown in FIGS. 1A-1D, the display screen 100 comprises the first section 102 and the second section 104 along the horizontal direction. The first section 102 is of a horizontal size (i.e., the size 128). This horizontal size is fixed relative to the user input 110 displayed in the user input region 108. In one embodiment, the horizontal size of the first section 102 is smaller than the full horizontal size of the display screen 100. In this embodiment, the first section 102 comprises the user input region 108 and the portion 122 used to display the first data 118. In fact, the user input region 108 and the portion 122 used to display the first data 118 are aligned vertically in the first section 102.

Similar to the phraseology relating to the fixed size 112 of the user input region 108, the phrase “size of the first section in the first direction is fixed” does not mean that the size 128 cannot be changed at any time, but simply means that the size 128 is not responsive to any user input 110 destined for the user input region 108. A user may still alter the size 128 of the first section 102 by invoking some preference configuration functionality. For example, a configuration page, such as an “internet options” page provided by an internet browser, may be used to set an appropriate value for the size 128 of the first section 102.

In some embodiments, similar to the fixed size 112 of the user input region 108, the size 128 of the first section 102 is determined programmatically by the electronic device based on characteristics of the display screen 100. Preferably, the size 128 of the first section 102 thus determined or configured is smaller than a full size, along the first direction 106, of the display screen 100.

For example, in some embodiments where the first direction 106 is the left-to-right horizontal direction and the second direction 116 is the downwards horizontal direction, as shown in FIGS. 1A-1D, the size 128 of the first section 102 is determined programmatically by the electronic device based on characteristics of the display screen 100 including size, resolution, color depth, etc.

In one embodiment, in addition to relating to the first data 118, the user input 110 also relates to second data 130. For example, in a situation where the user input 110 is a searchable text, the second data 130 can be some data based on the searchable text, such as search results returned by a search engine. In one embodiment, where the first data 118 is a list of suggestions, the search results (i.e., the second data 130) are directly linked to one suggestion in the list of suggestions. Since the list of suggestions is related to the searchable text, the second data 130 (i.e., the search results) is also indirectly related to the searchable text. At the same time as the user inputs characters through the input means, the search engine may concurrently retrieve (or, in one particular embodiment, formulate based on data the search engine keeps) the second data 130 related to the searchable text (whether the searchable text has been formally submitted for search by the user or not). In one embodiment, retrievals, or formulation, of the second data 130 performed by the search engine occur more than once and are triggered upon certain criteria being met—for example, when a space character is inputted after a preceding word, after a carriage return is typed, etc.

### Query User Input and Search Results

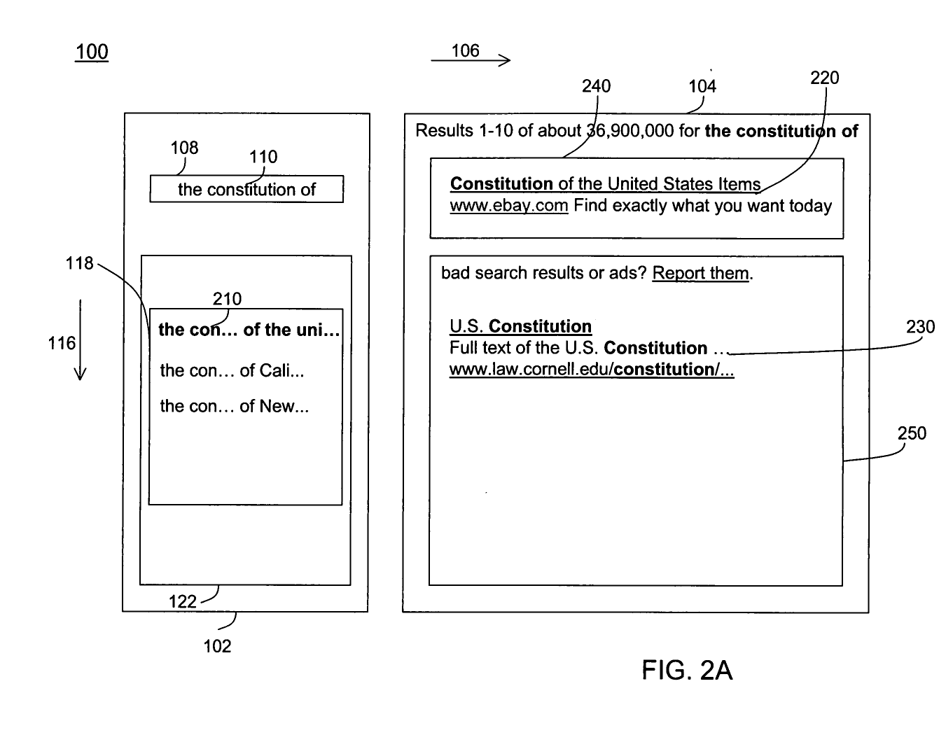

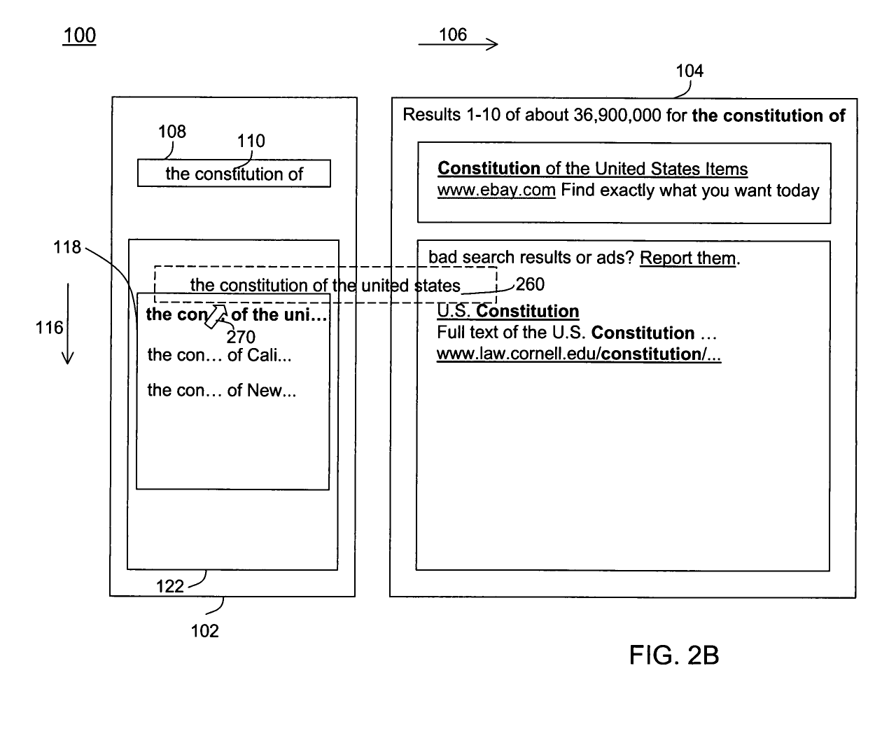

FIGS. 2A and 2B illustrate a display screen 100 for supporting interaction between user input and search results, according to an embodiment of the present invention. As user input 110 is, for example, being typed in by a user, the user input 110 (“the constitution of”, for example) is displayed and rendered in a user input region 108 of FIG. 2A. Concurrently, the UI mechanism interacts with a server (e.g., a search engine, a query suggestion server, etc.), which is operatively connected to the electronic device on which the UI mechanism is implemented. In one embodiment, the server, which may or may not be a search engine, provides the electronic device, and/or the UI mechanism a list of suggestions associated with the user input 110. The list of suggestions constitutes first data 118, which is displayed in a portion 122 of the display screen 100.

For the purpose of illustration, only three suggestions are shown in FIG. 2A. However, this invention is not limited to showing three suggestions. There may be more or fewer than three suggestions that may be shown in the portion 122 of the display screen 100. Variations of numbers of suggestions shown in the display screen 100 are within the scope of the present invention.

In one embodiment, among the suggestions, one suggestion is identified as a primary interaction path 210. In one embodiment, the UI mechanism highlights the primary interaction path 210 by boldfacing it. For instance, in the current example, the primary interaction path is identified as “the con . . . of the uni . . . ”, which is shown as the first item of the three suggestions in boldface in FIG. 2A. For the purpose of illustration, highlighting the primary interaction path 210 has been described as boldfacing it. However, this invention is not so limited. The UI mechanism may use a different way to highlight the primary interaction path 210 besides boldfacing. For example, another way of highlighting the primary interaction path 210 may be, but is not limited to, underlining.

In one embodiment, a primary interaction path is identified using ranking information associated with each suggestion. In one particular embodiment, the UI mechanism identifies the primary interaction path. In another embodiment, a server such as the search engine identifies the primary interaction path. In one embodiment, the ranking information associated with each suggestion is included in the first data 118 and displayed in the portion 126, and provides an indication of popularity of that particular suggestion as a search term. In one embodiment, a suggestion is identified as a primary interaction path if the suggestion represents the most popular search term among all the suggestions that are related to the user input 110.

As a suggestion is identified as the primary interaction path 210, the UI mechanism can make a request to retrieve search results for the suggestion, in one embodiment. In another embodiment, a server, which is operatively coupled to the electronic device and may or may not be the search engine, automatically identifies the primary interaction path 210 and returns the search results associated with the primary interaction path 210. The search results associated with the primary interaction path 210 constitute second data.

In one embodiment, the search results comprise first search results 220 and second search results 230. The first search results 220 are related to sponsor links in one embodiment. The second search results 230 come from searching the internet in one embodiment. In one embodiment, as shown in FIG. 2A, the first search results 220 and the second search result 230 are displayed in their respective portions 240 and 250 of the display screen 100.

As shown in FIGS. 2A and 2B, one or more words in a suggestion may be truncated when displayed. For example, the word “constitution” may be truncated to “con” in a displayed suggestion. This does not create any undue confusion as the user can readily correlate the shorthand notation (i.e., the truncated word) with the original word (i.e., a word that the user types and is displayed in the user input region 108).

In one embodiment, referring to FIG. 2B, a tooltip 260 is displayed when the user generates a suitable user interface event or action that is associated with a suggestion. The suitable user interface event or action may be triggered, for example, by placing a mouse 270 over the suggestion as shown in FIG. 2B. Other methods of triggering a suitable user interface event or action such as a (right) button click can also be used in various embodiments.

In one embodiment, the tooltip 270 displays a non-truncated version of the suggestion that is displayed in the portion 122 of the display screen 100. Furthermore, physical dimensions of the tooltip 270 may extend beyond the first section 102, for example, into the second section 104.

### Example Operation

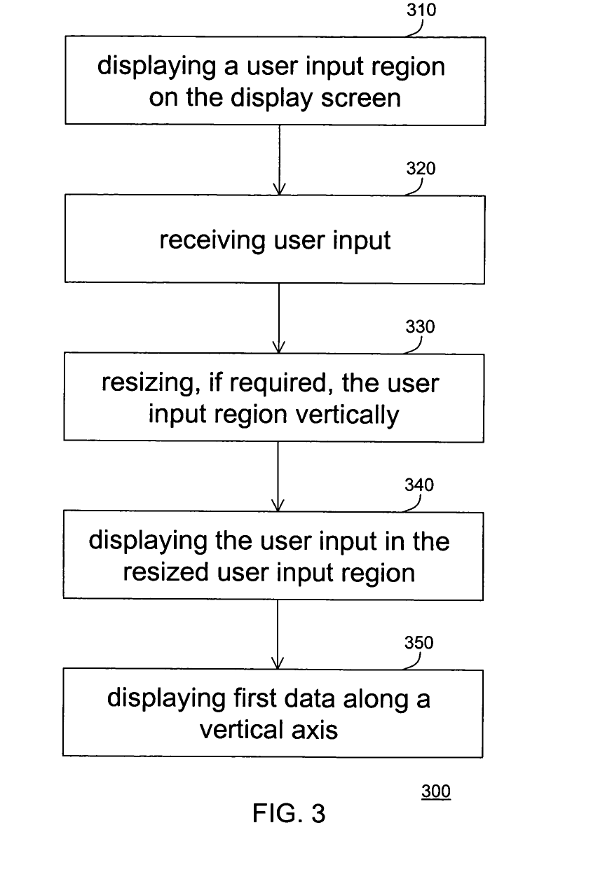

FIG. 3 is a flow diagram that illustrates a process 300 for supporting interaction between user input and data related to the user input using a display screen, according to an embodiment of the present invention. In block 310, the UI mechanism determines a horizontal size 112 that is smaller than a full horizontal size of the display screen 100. A user input region 108 is displayed with the horizontal size determined on the display screen 100.

In block 320, user input 110, which could fit in a single horizontal line of the display screen 100 if the user input region 108 were to be resized horizontally, is received through an input means. In block 330, the UI mechanism determines that the user input region 108 no longer fits the user input 110 and, as a result, resizes the user input region 108 vertically to adapt it to the user input 108.

In block 340, the user input 110 is rendered or displayed in the user input region 108, which has been resized to adapt the user input 110. In block 350, first data 118 that is related to the user input 110 is displayed or rendered in a portion 122 of the display screen 100. In one embodiment, the user input 110 and the first data 118 is visually aligned along a vertical axis 120.

### Hardware Overview

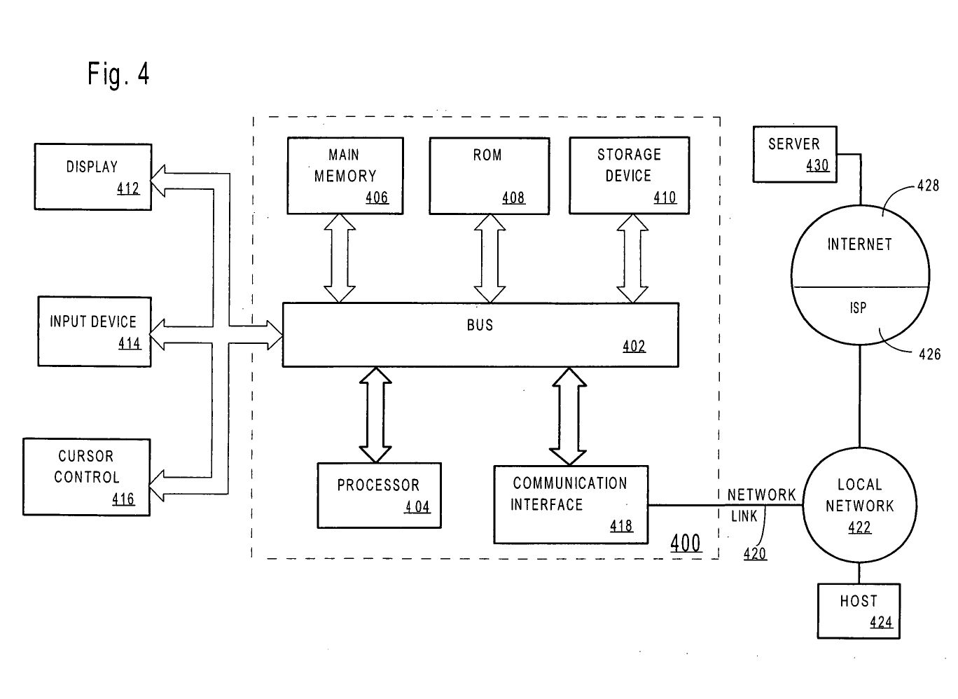

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may be used to implement the techniques described herein. According to one embodiment of the invention, those techniques are performed by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein said instructions are instructions which, when executed by one or more processors, cause the one or more processors to perform certain steps including:
displaying a user input region on the display screen, wherein the user input region is of a horizontal size smaller than a full horizontal size of the display screen;
receiving user input, wherein the user input could fit in a single horizontal line of the display screen if the user input region were to be resized horizontally;
resizing the user input region vertically to adapt the user input region to the user input;
displaying the user input in the user input region, as resized to adapt the user input region to the user input; and
displaying first data that is related to the user input in a portion of the display screen, wherein the user input and the first data is visually aligned along a vertical axis;
wherein the machine-executed operation is at least one of (a) sending said instructions over transmission media, (b) receiving said instructions over transmission media, (c) storing said instructions onto a machine-readable storage medium, and (d) executing the instructions.

2. A method as recited in claim 1, wherein displaying the first data comprises updating the first data to reflect the user input that is currently displayed in the user input region.

3. A method as recited in claim 1, wherein receiving user input comprises adding one or more characters.

4. A method as recited in claim 1, wherein receiving user input comprises removing one or more characters.

5. A method as recited in claim 1, wherein resizing the user input region comprises expanding the user input region vertically.

6. A method as recited in claim 1, wherein resizing the user input region comprises shrinking the user input region vertically.

7. A method as recited in claim 1, wherein the vertical axis divides the user input region into two substantially equal halves.

8. A method as recited in claim 1, wherein horizontal boundaries of the user input region are substantially aligned with horizontal boundaries of the portion used to display the first data that is related to the user input.

9. A method as recited in claim 1, wherein resizing the user input region vertically includes resizing the user input region vertically in an upwards direction.

10. A method as recited in claim 1, wherein resizing the user input region vertically includes resizing the user input region vertically in a downwards direction.

11. A method as recited in claim 1, wherein resizing the user input region vertically includes resizing the user input region vertically in a both upwards and downwards directions.

12. A method as recited in claim 1, further comprising altering one or more attributes of a font that is used to render the user input in the user input region, wherein the one or more attributes of the font includes a font size.

13. A method as recited in claim 1, wherein the display screen comprises a first section and a second section aligned along a horizontal axis, wherein the first section is of a horizontal size that is fixed relative to the user input displayed in the user input region, wherein the horizontal size of the first section is smaller than the full horizontal size of the display screen, and wherein the first section comprises the user input region and the portion used to display the first data that is related to the user input.

14. A method as recited in claim 13, wherein the horizontal size of the first section is configurable.

15. A method as recited in claim 13, further comprising displaying second data in the second section which second data is related to the user input.

16. A method comprising performing a machine-executed operation involving instructions, wherein said instructions are instructions which, when executed by one or more processors, cause the one or more processors to perform certain steps including:
determining a fixed size in a first direction, wherein the fixed size in the first direction is smaller than a full size, in the first direction, of the display screen;
rendering an input region in the display screen, wherein the input region is restricted in the first direction to no more than the fixed size, and wherein the input region is sized in a second direction to an initial value of a non-fixed size;
receiving user input;
determining whether the user input fits the input region assuming a desired presentation format;
in response to a determination that the user input does not fit the input region, resizing the input region in the user interface along or against the second direction to adapt the input region to the user input;
displaying the user input in the input region, as resized to adapt the input region to the user input; and
displaying first data that is related to the user input in a portion of the display screen, wherein the user input and the first data is visually aligned with a first axis that is along the second direction;
wherein the machine-executed operation is at least one of (a) sending said instructions over transmission media, (b) receiving said instructions over transmission media, (c) storing said instructions onto a machine-readable storage medium, and (d) executing the instructions.

17. A method as recited in claim 16, wherein the user input comprises adding one or more characters.

18. A method as recited in claim 16, wherein the user input comprises removing one or more characters.

19. A method as recited in claim 16, wherein resizing the user input region comprises expanding the user input region along or against the second direction.

20. A method as recited in claim 16, wherein resizing the user input region comprises simultaneously expanding the user input region along and against the second direction.

21. A method as recited in claim 16, wherein resizing the user input region comprises shrinking the user input region along or against the second direction.

22. A method as recited in claim 16, wherein resizing the user input region comprises simultaneously shrinking the user input region along and against the second direction.

23. A method as recited in claim 16, further comprising altering one or more attributes of a font that is used to render the user input in the user input region, wherein the one or more attributes of the font includes a font size.

24. A method as recited in claim 16, wherein the display screen comprises the first section and a second section aligned with a second axis along the first direction, wherein the first section is of a size in the first direction which size is fixed relative to the user input displayed in the user input region, wherein the size of the first section in the first direction is smaller than the full size of the display screen in the first direction, and wherein the first section comprises the user input region and the portion used to display the first data that is related to the user input.

25. A method as recited in claim 24, wherein the size of the first section in the first direction is configurable.

26. A method as recited in claim 24, further comprising displaying second data in the second section which second data is related to the user input.
